(19) United States
(12) Patent Application Publication
(10) Pub. No.: US 2007/0240299 A1
(43) Pub. Date: Oct. 18, 2007

(54) Method for forming functional film, method for manufacturing electrode, and method for manufacturing secondary cell

(75) Inventor: Hironori Hasei, Okaya-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/783,044

(22) Filed: Apr. 5, 2007

(30) Foreign Application Priority Data
Apr. 17, 2006 (JP) JP 2006-112981
Jan. 16, 2007 (JP) JP 2007-006670

(51) Int. Cl. H01M 4/04; B05D 5/12; B05D 1/36

(52) U.S. Cl. 29/623.5; 427/58; 427/402

(57) ABSTRACT

A method is provided for forming a functional film having at least first and second functional materials arranged in accordance with a prescribed coating pattern on a substrate. The method includes discharging the first functional material having a smaller coating surface area than the second functional material according to the prescribed coating pattern onto the substrate using a droplet discharge apparatus, and discharging the second functional material according to the prescribed coating pattern onto the substrate using the droplet discharge apparatus after the first functional material is discharged onto the substrate.

### CROSS-REFERENCE TO RELATED APPLICATIONS

This application claims priority to Japanese Patent Application Nos. 2006-112981 filed on Apr. 17, 2006 and 2007-006670 filed on Jan. 16, 2007. The entire disclosures of Japanese Patent Application Nos. 2006-112981 and 2007-006670 are hereby incorporated herein by reference.

### BACKGROUND

1. Technical Field

The present invention relates to a method for discharging two or more functional materials onto a substrate by using a droplet discharge apparatus to form a functional film having a prescribed pattern, a method for manufacturing an electrode by using the method for forming a functional film, and a method for manufacturing a secondary cell by using the method for manufacturing an electrode.

2. Related Art

In recent years, electric vehicles (EV), hybrid vehicles (HEV), and fuel cell vehicles (FCV) have come to be used in commercial applications, and the development of cells as a power source for these vehicles is being carried out at a high pitch. There is a demand for cells that are capable of repeated charging and discharging, that have high output and high energy density, and that satisfy other very rigorous requirements. In order to satisfy these requirements, Japanese Laid-Open Patent Application Publication No. 2003-151526 proposes a cell in which plate-shaped positive and negative electrodes are accommodated in an enclosure, a liquid electrolyte is sealed in the container to form a thin stacked cell, and several of these secondary cells are connected in a series-parallel configuration.

However, the thickness of the electrode must be further reduced because numerous cells must be connected in series when such a cell is used as a power source of a vehicle or the like in which high output is required.

Methods for forming a thin electrode have been proposed in, e.g., Japanese Laid-Open Patent Application Publication Nos. 2005-11656, 2005-11657 and 2005-135599, wherein a composition for forming an electrode layer is discharged as droplets on a substrate to form a very thin electrode layer by using the inkjet method (a method that uses a droplet discharge apparatus) for depositing the droplets on a substrate.

Moreover, Japanese Laid-Open Patent Application Publication No. 2005-135599 discloses a method in which desired charging and discharging characteristics are imparted to the electrodes of a secondary cell by applying a plurality of compositions for forming an electrode layer containing electroconductive materials and active materials having different electrical characteristics to a substrate in accordance with a pre-designed pattern by using a droplet discharge apparatus.

Creation of smaller and thinner secondary cells in recent years has created a demand for forming detailed patterns on electrode layers as well.

However, methods that use a conventional droplet discharge apparatus are disadvantageous in that bleeding occurs along a boundary when droplets of different types of compositions come into close proximity so that the pattern is degraded and cannot be formed as designed.

The present invention was contrived in view of the foregoing state of the prior art, and an object thereof is to provide a method for forming a functional film whereby two or more functional materials are discharged onto a substrate by using a droplet discharge apparatus to form a functional film composed of two or more functional materials, wherein bleeding at the boundary of a pattern is reduced and a functional film can be formed in a pattern that is in close approximation to an intended pattern; to provide a method for manufacturing an electrode by using the method for forming a functional film; and to provide a method for manufacturing a secondary cell by using the method for manufacturing an electrode.

### SUMMARY

The present inventors carried out thoroughgoing research to solve the above-described problems in relation to a method for manufacturing an electrode whereby two or more materials for forming an electrode layer are discharged onto a substrate by using a droplet discharge apparatus to form an electrode layer composed of two or more materials for forming an electrode layer. As a result, it is discovered that bleeding at the boundary of a pattern does not occur and an electrode layer can be formed in accordance with an intended pattern when an electrode layer having a prescribed pattern is formed by first applying the material having the least or smallest coating surface area in relative terms among the two or more types of electrode-forming material, and then applying the material having the greatest coating surface area in relative terms, to a substrate in accordance with a prescribed coating pattern.

Thus, in accordance with the first aspect of the present invention, there is provided a method for forming a functional film wherein two or more functional materials are discharged onto a substrate by using a droplet discharge apparatus to form a functional film having the two or more functional materials, the method comprising forming a functional film having a prescribed pattern by first applying the material having the smallest coating surface area in relative terms among the two or more functional materials, and then applying the material having the greatest coating surface area in relative terms, to a substrate in accordance with a prescribed coating pattern.

In accordance with the method for forming a functional film according to the present invention, a functional film having an intended pattern can be formed without bleeding at the boundary and without degradation of the designed pattern when different functional materials are coated in close proximity (to each other) in accordance with a prescribed pattern by using a droplet discharge apparatus.

In accordance with the second aspect of the present invention, there is provided a method for manufacturing an electrode wherein two or more materials for forming an electrode layer are discharged onto a collector to form an electrode layer composed of the two or more materials for forming an electrode layer, comprising the step of forming an electrode film having a prescribed pattern by first applying the material having the smallest coating surface area in relative terms among the two or more electrode layer-forming material, and then applying the material having the greatest coating surface area in relative terms, to a substrate in accordance with a prescribed coating pattern.

In the method for manufacturing an electrode according to the present invention, materials composed of at least one positive electrode active material and at least one carbon-based electroconductive material are preferably used as the two or more materials for forming an electrode layer to form a positive electrode of a secondary cell.

In the method for manufacturing an electrode according to the present invention, an electrode having an electrode layer formed to a uniform thickness in accordance with an intended pattern can be manufactured without bleeding at the boundary.

In accordance with the third aspect of the present invention, there is provided a method for manufacturing a secondary cell having a negative electrode, an electrolyte, and a positive electrode layer composed of two or more positive electrode materials, comprising the step of forming the positive electrode layer having a prescribed pattern to form a positive electrode by first applying the material having the smallest coating surface area in relative terms among the two or more positive electrode materials, and then applying the material having the greatest coating surface area in relative terms, to a collector in accordance with a prescribed coating pattern.

In accordance with the method for manufacturing a secondary cell according to the present invention, a large-capacity secondary cell having the desired charging and discharging characteristics can be obtained because an electrode having an electrode layer that is not degraded can be manufactured.

In accordance with the fourth aspect of the present invention, there is provided a method for forming a functional film that includes first and second functional film patches composed of mutually different functional materials, wherein the first and second functional film patches are configured so as to be in mutual contact with part of a boundary, the method comprising a determination step for determining a first area corresponding to the first functional film patch and a second area corresponding to the second functional film patch; a first coating step for applying the corresponding functional material-containing liquid material to the area that has the least surface area in relative terms and is selected from the first and second areas; and a second coating step for applying, after the first coating step, the corresponding functional material-containing liquid material to the area that has the greatest surface area in relative terms and is selected from the first and second areas.

In the method for forming a functional film according to the present invention, the first and second coating steps are preferably carried out by discharging the liquid material toward the substrate by using a droplet discharge apparatus.

Coated liquid materials become wetted and spread from the coated position. Liquid materials coated first become wetted and spread beyond a prescribed range in which a functional film patch is to be formed by the liquid material, and it is possible that the coatable range of the liquid material applied thereafter may thereby be reduced and the surface area of the functional film patch composed of the later coated liquid material may also be reduced. When the reduced surface areas are the same, the effect of the reduction will increase as the set surface area is reduced. In the method for forming a functional film according to the present invention, a functional film can be formed having at least the initially coated surface area in smaller areas by first applying the liquid material to the smaller areas. The effect of errors in the surface area of the functional film can therefore be reduced.

Since the amount of coated liquid material generally increases as the surface area to be coated increases, there is greater possibility that the error of the range in which the liquid material will wet and spread will increase. The shape error of the functional film patch corresponding to a set pattern can be reduced and a functional film that is more proximate to the intended pattern can be formed by first applying the liquid material in areas having less surface area to reduce the error of the wetting range. The error of the coating position and coating shape of the liquid material corresponding to a set pattern can be furthermore reduced by discharging the liquid material toward the substrate with the aid of a droplet discharge apparatus that can deposit a liquid in any position with good accuracy.

In accordance with the fifth aspect of the present invention, there is provided a method for manufacturing an electrode composed of an electrode layer that includes first and second electrode layer patches composed of mutually different electrode layer materials, wherein the first and second electrode layer patches are configured so as to be in mutual contact with part of a boundary, the method comprising a determination step for determining a first area corresponding to the first electrode layer patch and a second area corresponding to the second electrode layer patch; a first coating step for applying the corresponding liquid material containing an electrode layer material to the area that has the least surface area in relative terms and is selected from the first and second areas; and a second coating step for applying, after the first coating step, the corresponding liquid material containing an electrode layer material to the area that has the greatest surface area in relative terms and is selected from the first and second areas.

In the method for manufacturing an electrode according to the present invention, the liquid material containing an electrode layer material preferably has at least a liquid material that contains a positive electrode active material, and a liquid material that contains a carbon-based electroconductive material; and the electrode having an electrode layer is a positive electrode of a secondary cell.

In the method for manufacturing an electrode according to the present invention, the first and second coating steps are preferably carried out by discharging the liquid material containing an electrode layer material toward the substrate with the aid of a droplet discharge apparatus.

In the method for manufacturing an electrode according to the present invention, a functional film can be formed having at least the initially coated surface area in smaller areas by first applying the liquid material to the smaller areas. The error of the wetting range can be reduced by first applying the liquid material to the smaller areas. The error of the coating position and coating shape of the liquid material can be reduced by using a droplet discharge apparatus. Therefore, the shape error of the electrode layer patch corresponding to a set pattern can be reduced and a positive electrode or another electrode of a secondary cell can be formed to obtain an electrode layer that is more proximate to the intended pattern.

In accordance with the sixth aspect of the present invention, there is provided a method for manufacturing a secondary cell provided with a negative electrode, an electrolyte, and a positive electrode composed of a positive electrode layer that includes first and second electrode layer patches composed of mutually different positive electrode layer materials, wherein the first and second electrode layer patches are configured so as to be in mutual contact with part of a boundary, the method comprising a determination step for determining a first area corresponding to the first positive electrode layer patch and a second area corresponding to the second positive electrode layer patch; a first coating step for applying the corresponding positive liquid material containing an electrode layer material to the area that has the least surface area in relative terms and is selected from the first and second areas; and a second coating step for applying, after the first coating step, the corresponding positive liquid material containing an electrode layer material to the area that has the greatest surface area in relative terms and is selected from the first and second areas.

In accordance with the method for manufacturing a secondary cell of the present invention, a functional film can be formed having at least the initially coated surface area in smaller areas by first applying the liquid material to the smaller areas. The error of the wetting range can be reduced by first applying the liquid material to the smaller areas. Therefore, the shape error of the electrode layer patch corresponding to a set pattern can be reduced and a secondary cell having characteristics that are more proximate to the intended characteristics can be manufactured by forming a positive electrode having an electrode layer that is more proximate to the intended pattern.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic diagram showing an example of the droplet discharge apparatus used in an illustrated embodiment of the present invention;

FIG. 2 is a flowchart showing the order of steps of the method for forming a functional film according to the illustrated embodiment the present invention;

FIG. 3 is a pair of schematic diagrams (a) and (b) showing an example of a pattern for the functional film obtained using the present invention wherein the diagram (a) is a simplified top plan view of a substrate and the diagram (b) is a simplified partial cross sectional view of an encircled portion the substrate in the diagram (a) according to the illustrated embodiment of the present invention;

FIG. 4 is a pair of schematic diagrams (a) and (b) showing an example of a pattern for a positive electrode layer manufactured using the illustrated embodiment of the present invention, wherein the diagram (a) is a simplified cross sectional view of the pattern for the positive electrode layer and the diagram (b) is a simplified top plan view of the pattern for the positive electrode layer;

FIG. 5 is a plurality of schematic diagrams (a) to (d) showing a various examples of a pattern for a positive electrode layer manufactured using the illustrated embodiment of the present invention;

FIG. 6 is an overall schematic diagram showing an example of the manufacturing line used to manufacture the secondary cell of the illustrated embodiment of the present invention;

FIG. 7 is a schematic diagram showing an example of the manufacturing line used to manufacture the electrode of the illustrated embodiment of the present invention; and

FIG. 8 is a simplified schematic diagram showing an example of the lithium secondary cell obtained using the illustrated embodiment of the present invention.

### DETAILED DESCRIPTION OF THE PREFERRED EMBODIMENTS

Selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

### Method for Forming Functional Film

The method for forming a functional film according to the present invention entails forming a functional film wherein two or more functional materials are discharged onto a substrate by using a droplet discharge apparatus to form a functional film having the two or more functional materials, the method comprising forming a functional film having a prescribed pattern by first applying the material having the smallest coating surface area in relative terms among the two or more functional materials, and then applying the material having the greatest coating surface area in relative terms, to a substrate in accordance with a prescribed coating pattern.

As used herein, the term “pattern” refers to a pattern that has been designed so that two or more functional materials having different functions are deposited in prescribed areas on a substrate. The pattern is semi-empirically designed so that a functional film having the desired functional characteristics is obtained.

The term “functional characteristics” refers to the charging and discharging characteristics of a secondary cell having a positive electrode layer when a functional film is the positive electrode layer of a positive electrode of a secondary cell.

The functional material having the smallest coating surface area in relative terms is a material having the smallest coating surface area in a designed pattern. The volume of the particles discharged using the droplet discharge apparatus is substantially the same. Therefore, the functional material having the smallest coating surface area is the material having the least applicable capacity (applicable weight) among the materials to be coated.

The method for forming a functional film according to the present invention is a method for discharging two or more functional materials by using a droplet discharge apparatus to form a functional film composed of two or more functional materials.

The method for forming a functional film according to the present invention may be a method a functional film whereby as a layered body having functional layers composed of two or more functional materials is formed on a substrate, or may be a method whereby a functional film composed of two or more functional materials that has a prescribed pattern in the same plane is formed on the same flat surface of the substrate.

In the present invention, an inkjet discharge apparatus, for example, is used as the means for coating the functional materials. The method for discharging in the inkjet method is not particularly limited, and examples include thermal discharge apparatuses that generate foam by using thermal foaming to discharge the droplets, and piezo-type discharge apparatuses that discharge droplets by using the compression of a piezo element.

The volume of the droplets discharged by the discharge apparatus is preferably in a range of 1 to 100 pL.

With the inkjet method, the uniformity of the resulting film thickness is very high, and a highly uniform film thickness can be obtained even when the same pattern is layered numerous times. In the formation of each layer, a functional film that does not have pattern degradation can be formed by adopting a method in which the functional material having the smallest coating surface area is applied first.

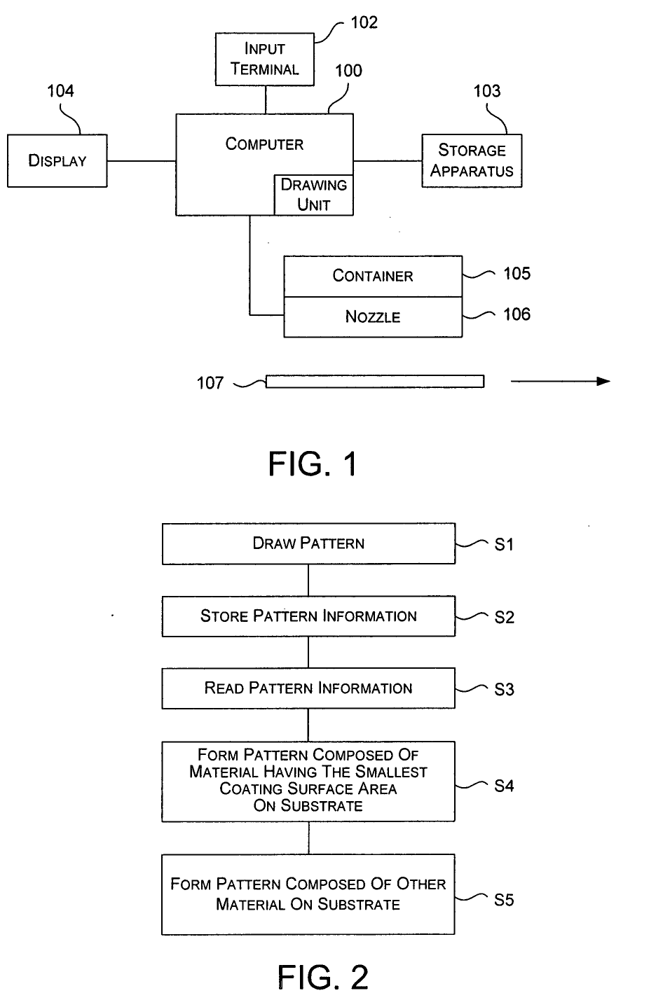

FIG. 1 is a diagram showing a schematic of an example of the droplet discharge apparatus used in the present invention. The droplet discharge apparatus 10 shown in FIG. 1 is provided with a computer 100, an input terminal 102 connected to the computer 100, a display 104, a storage apparatus 103, and a discharge nozzle 106.

The computer 100 is provided with a drawing unit 101. The drawing unit 101 draws patterns on the basis of information inputted from the input terminal 102.

The display 104 displays the patterns drawn by the computer 100.

The storage apparatus 103 stores the pattern that the computer 100 has ultimately generated.

The discharge nozzle 106 discharges a composition onto a substrate 107 in accordance with a pattern stored in the storage apparatus 103.

The operation of the discharge nozzle 106 is controlled by the computer 100.

A container 105 for storing a composition containing a first functional material having a relatively small coating surface area (hereinafter referred to as “composition A”) and composition containing a second functional material having a relatively large coating surface area (hereinafter referred to as “composition B”) is mounted on the discharge nozzle 106.

When the compositions A and B are discharged using a single droplet discharge apparatus, the container 105 is partitioned for each composition, and dedicated discharge nozzles 106 assigned to the compositions are connected to the container. The container 105 may be provided with an agitator and a heater as required.

FIG. 2 is a flowchart showing the order of steps of the method for forming a functional film according to the present invention.

First, information that is required for drawing a pattern is inputted from the input terminal 102 to the computer 100. This information specifies pattern shapes, pattern sizes, pattern placement locations, and pattern colors.

The drawing unit 101 of the computer 100 draws a pattern on the basis of the inputted information (S1), and the pattern is displayed on the display 104. The information of the displayed pattern (pattern information) is stored in the storage apparatus 103 (S2).

The computer 100 accesses the storage apparatus 103 and reads out the stored pattern information (S3).

Composition A having a relatively low surface area is discharged from the discharge nozzle as droplets and is applied to a prepared desired substrate in accordance with the pattern information thus read out (S4).

When the discharge of composition A has been completed, composition B is then similarly discharged in accordance with the pattern onto the substrate on which composition A had been discharged (S5).

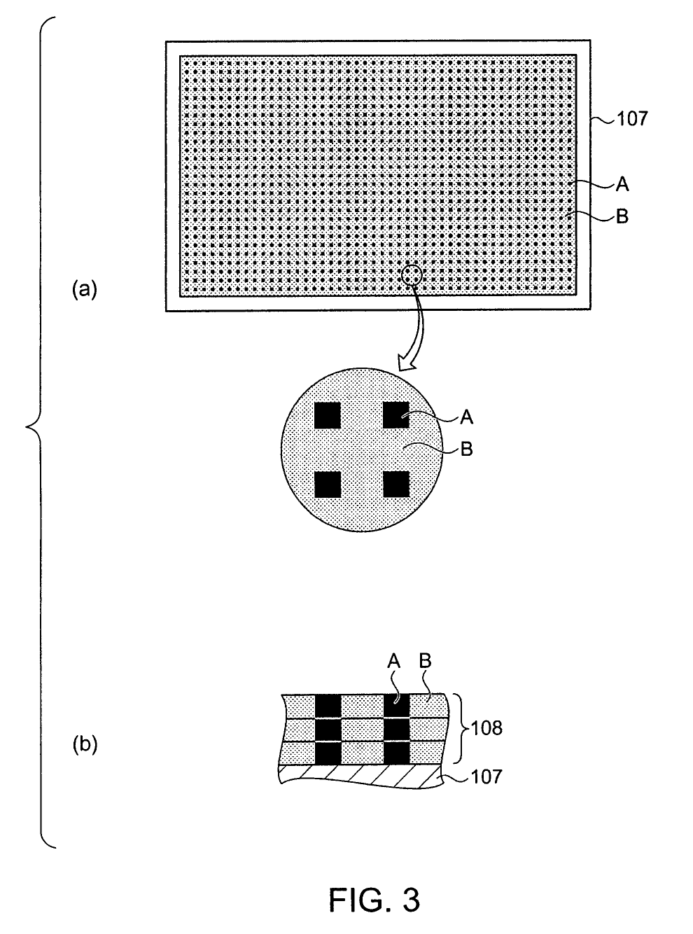

Steps (S4) and (S5) are described below with reference to an example of a case in which a functional film 108 is formed in accordance with the pattern shown in the diagrams (a) and (b) of FIG. 3. The diagram (a) of FIG. 3 is a plan view that schematically shows an example of a pattern for the functional film, and the diagram (b) of FIG. 3 is a diagram that schematically shows a cross section of an example of a pattern for the functional film. The pattern shown in the diagrams (a) and (b) of FIG. 3 is designed so that composition A is applied to the black-filled (hereinafter referred to as “black”) area A in the diagram, and composition B is applied to the area having a half-tone dot meshing (hereinafter referred to as “gray”) in the diagram. When the surface areas of the black area A and gray area B are compared, it can be seen that the surface area of the black area A is relatively small. The gray area B is an integrally connected area, and the black area A is separated into a plurality of areas. The surface area of the black area A is much less than the surface area of the gray area B. Therefore, composition A is discharged in the black area A on the substrate 107 by using the droplet discharge apparatus 10 described above, and when the discharge of composition A has been completed, composition B is discharged in the gray area B.

Each of the plurality of areas constituting the black area A is set to be the same size, and the discharge order in the areas may be arbitrary.

Composition A is dried and a functional film of composition A is formed in the black area A. The precoated black area A is continuously dried until composition B is applied thereafter. Therefore, at the point in time when composition B is applied thereafter, the functional film of composition A is substantially formed in the black area A. For this reason, the possibility that mixing will occur at the boundary where the coated compositions A and B are adjacent to each other is very low.

The coated compositions become wet and spread from the coated positions. The first applied composition becomes wet and spreads beyond a prescribed range in which the composition is to be formed, and it is possible that the coatable range of the subsequently applied composition can be reduced together with the surface area of the functional film composed of the subsequently applied composition. When the reduced surface areas are the same, the effect of the reduction will increase as the set surface area is reduced. In the particular case that the surface area to be coated is less than the discharge accuracy of the droplet discharge apparatus, it is possible that the periphery is coated before to the small area is coated, and the small area is substantially filled in and completely covered by the composition applied to the periphery. However, a functional film having at least the initially coated surface area can be formed by first coating the small area. Composition A is applied first to a set black area A, whereby the composition A is unaffected by the subsequently applied composition B.

The amount in which the composition is applied decreases with a reduction in the coated surface area. The surface area that can be wetted and spread beyond a set range increases with an increase in the amount in which the composition is applied. For this reason, the amount of displacement between the set boundary and the boundary between the functional films formed when the wetting and spreading has exceeded a set range can be reduced by coating a smaller area first rather than coating a larger area first, even when wetting and spreading has exceeded a set range. By first applying composition A, a film of composition A or composition B can be more accurately formed in comparison with the case in which the boundary between composition A and composition B is determined by the wetting and spreading of composition B applied over the entire integral gray area B when composition B is applied first.

In this manner, by applying first composition A and then composition B, the droplets of the coated composition A and the droplets of composition B are less likely to bleed in the adjacent boundaries than when composition B is applied first and composition A is applied later, or when composition A and composition B are applied substantially simultaneously. Therefore, an intended pattern can be formed without pattern degradation.

The functional film formed by the method for forming a functional film according to the present invention is not particularly limited as long as it is a thin film having a prescribed pattern formed by discharging two or more functional materials in prescribed areas on a substrate by using a droplet discharge apparatus. Examples include a functional film composed of an insulation layer and an electroconductive layer having a prescribed pattern on a circuit board used as a substrate, and a positive electrode layer composed of an electroconductive material and a positive electrode active material having a prescribed pattern on a collector as described below.

### Method for Manufacturing Electrode

The method for manufacturing an electrode according to the present invention is one in which the method for forming a functional film according to the present invention is used to manufacture an electrode. The method for manufacturing an electrode according to the present invention is one in which two or more materials for forming an electrode layer are discharged onto a collector to form an electrode layer composed of the two or more materials for forming an electrode layer, the method comprising the step of forming an electrode film having a prescribed pattern by first applying the material having the smallest coating surface area in relative terms among the two or more electrode layer-forming material, and then applying the material having the greatest coating surface area in relative terms, to a substrate in accordance with a prescribed coating pattern.

The method for manufacturing an electrode according to the present invention is not particularly limited as long as the method is for manufacturing an electrode in which the electrode layer composed of two or more materials for forming an electrode layer are formed. However, the method is preferably a method for manufacturing a positive electrode of a secondary cell, or is preferably a method for manufacturing a positive electrode of a lithium ion secondary cell.

The method for manufacturing an electrode according to the present invention is one in which two or more materials for forming an electrode layer are discharged from a droplet discharge apparatus onto a collector to form an electrode layer.

The collector used in the present invention is not particularly limited as long as the material is in the form of a sheet comprising a electroconductive material, examples of which include aluminum, copper, nickel, and stainless steel that have been worked into the form of a metal foil, electrolytic foil, rolled foil, embossed article, foam sheet, or the like.

The thickness of the collector is not particularly limited and is ordinarily 5 to 30 μm.

The two or more materials for forming an electrode layer that are used in the present invention may be a combination of a positive electrode material and an electroconductive material.

The positive electrode active material is not particularly limited, and any known positive electrode active material can be used. Examples of materials that may be used when a positive electrode for a lithium cell is to be formed include LiMn₂O₄ and other Li—Mn-based complex oxides; LiCoO₂ and other Li—Co-based complex oxides; and LiNiO₂ and other Li—Ni-based complex oxides. These positive electrode active materials may be used alone or in a combination of two or more.

The electroconductive material is not particularly limited as long as the material has electroconductive characteristics. Examples include acetylene black, carbon black, Ketjen black, graphite, carbon fibers, carbon nanotubes, and other carbon-based electroconductive materials. These electroconductive materials may be used alone or in a combination of two or more.

In the present invention, dispersion fluids (composition for forming an electrode layer) in which the two or more electrode layer forming materials (e.g., first and second electrode layer forming materials) for forming an electrode layer are dispersed in a suitable organic solvent are prepared, the composition containing the material for forming an electrode layer that has the smallest coating surface area in relative terms is applied first by using a droplet discharge apparatus, and the composition containing the material for forming an electrode layer that has a large coating surface area in relative terms is applied thereafter.

The organic solvent that is used is not particularly limited, but from the standpoint of work efficiency, the organic solvent preferably has a boiling point in a range of 50° C. to 200° C. at normal pressure. Examples of such an organic solvent include N-methylpyrrolidone, N,N-dimethylformamide, N,N-dimethylacetamide, and other amide-based solvents; acetonitrile, propionitrile, and other nitrile-based solvents; tetrahydrofuran, 1,2-dimethoxy ethane, diisopropyl ether, and other ether-based solvents; acetone, methylethyl ketone, diethyl ketone, methyl isobutyl ketone, cyclohexanone, and other ketone-based solvents; ethyl acetate, propyl acetate, methyl lactate, and other ester solvents; benzene, toluene, xylene, chlorobenzene, and other aromatic solvents; chloroform, 1,2-dichloro ethane, and other halide solvents; and mixed solvents composed of two or more of these solvents.

In the present invention, the composition containing the electrode layer-forming material may contain other components as required. Examples of other components include polyvinylidene fluoride and other binding agents. These other components may be added to the composition that contains the positive electrode active material, or may be added to the composition that contains the electroconductive material.

The composition containing the positive electrode active material may be prepared by mixing/stirring the positive electrode active material and other components as required in the organic solvent. The method of mixing and stirring is not particularly limited, and conventionally known mixers/stirrers may be used.

The blending ratio of the positive electrode active material, other components, and organic solvent in the composition is not particularly limited. The blending amount of positive electrode active material is ordinarily 10 wt % to 60 wt % with respect to the entire composition. The blending amount of other components is ordinarily 0 wt % to 20 wt % with respect to the entire composition. The blending amount of organic solvent is ordinarily 20 wt % to 90 wt % with respect to the entire composition.

The composition containing the electroconductive material may be prepared by mixing/stirring the electroconductive material and other components as required in the organic solvent. The method of mixing and stirring is not particularly limited, and conventionally known mixers/stirrers may be used.

The blending ratio of the electroconductive material, other components, and organic solvent in the composition is not particularly limited. The blending amount of electroconductive material is ordinarily 10 wt % to 60 wt % with respect to the entire composition. The blending amount of other components is ordinarily 0 wt % to 20 wt % with respect to the entire composition. The blending amount of organic solvent is ordinarily 20 wt % to 90 wt % with respect to the entire composition.

The viscosity of the composition for forming the electrode layer (the composition that contains the positive electrode active material, and the composition that contains the electroconductive material) is not particularly limited, but is preferably low enough to allow droplets to be discharged. The viscosity of the composition is preferably about 1 to 100 cP. Examples of methods for adjusting the viscosity of the composition to achieve this range include methods that vary (increase or otherwise modify) the blending ratio of the organic solvent, methods that increase the temperature of the composition, and methods that add polyelectrolyte starting materials and other compounds to the composition so that the viscosity is reduced.

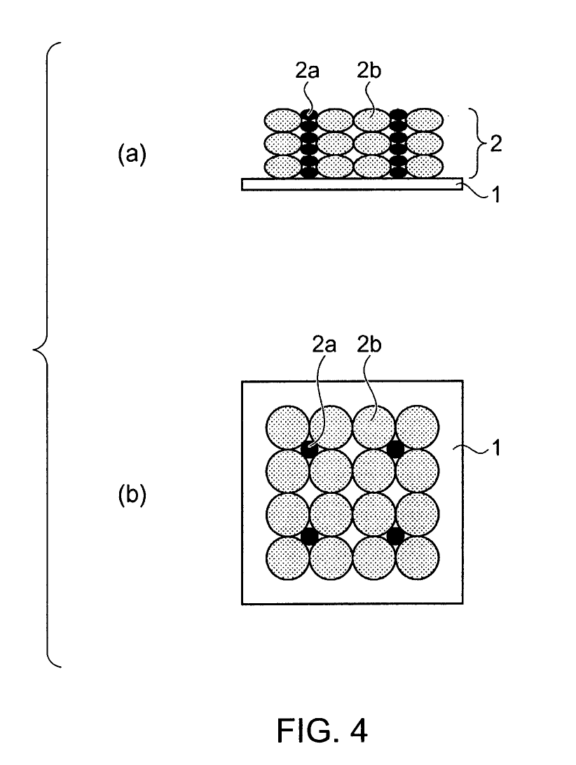

The diagrams (a) and (b) of FIG. 4 are diagrams schematically showing an example of a pattern (pattern on an enlarged scale) for a positive electrode layer manufactured using the present invention.

The positive electrode shown in the diagrams (a) and (b) of FIG. 4 has a collector 1, and a positive electrode layer 2 in which a positive electrode active material and an electroconductive material are formed in a prescribed pattern on the collector 1. The diagram (a) of FIG. 4 is a cross-sectional diagram showing the positive electrode as viewed from the side, and the diagram (b) of FIG. 4 is a plan view showing the positive electrode as viewed from above.

With the positive electrode layer 2 shown in the diagrams (a) and (b) of FIG. 4, a pattern portion 2b composed of a positive electrode active material having a relatively large coated surface area and pattern portion 2a composed of an electroconductive material having a relatively small coated surface area are disposed on the collector 1 so as to be positioned at the four vertices of a square.

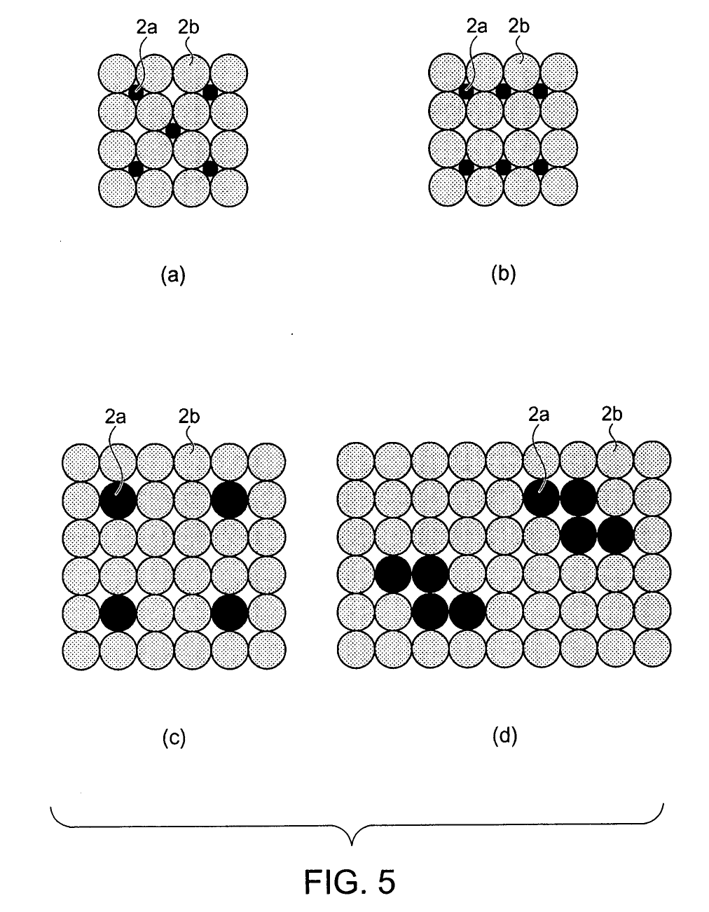

In the present invention, the arrangement of the pattern portion 2a and the pattern portion 2b is not limited to the pattern shown in the diagrams (a) and (b) FIG. 4, and any pattern arrangement can be used, as shown in the diagrams (a) to (d) of FIG. 5. In the diagram (a) of FIG. 5, for example, the pattern portion 2a may be arranged so as to be positioned at the four vertices of a square and at the center portion thereof, or may be arranged so as to have three units each positioned above and below (totaling 6 dots), as shown in the diagram (b) of FIG. 5. The size of the individual pattern portions 2a and pattern portions 2b may be substantially the same size, as shown in the diagrams (c) and (d) of FIG. 5. A plurality of pattern portions 2a may be in a mutually adjacent arrangement, as shown in the diagram (d) of FIG. 5.

In the present invention, the ratio of the total surface area of the pattern portion 2a constituting the positive electrode layer 2 and the total surface area of the pattern portion 2b is not particularly limited, but the total surface area of the pattern portion 2a is preferably 5% to 40% of the total surface area with respect to the pattern portion 2a and pattern portion 2b in the positive electrode of a lithium secondary cell.

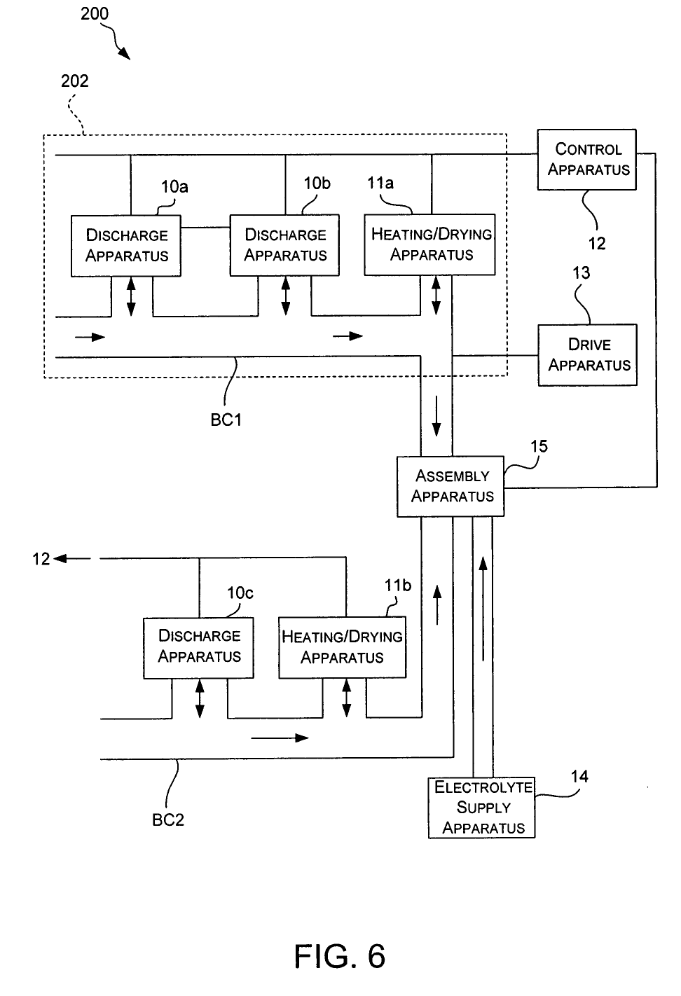

The method for manufacturing the positive electrode shown in the diagrams (a) and (b) FIG. 4 is described next. The positive electrode shown in the diagrams (a) and (b) FIG. 4 can be manufactured using the positive electrode manufacturing line 202 within the dotted line in the manufacturing line 200 of the secondary cell shown in FIG. 6, for example.

The positive electrode manufacturing line 202 is composed of a droplet discharge apparatus 10a (hereinafter referred to as “discharge apparatus 10a”) for discharging a composition containing an electroconductive material (hereinafter referred to as “composition a”), droplet discharge apparatus 10b (hereinafter referred to as “discharge apparatus 10b”) for discharging a composition containing a positive electrode active material (hereinafter referred to as “composition b”), a heating/drying apparatus 11a, and a belt conveyor BC1 for connecting the apparatuses. These apparatuses are connected to a drive apparatus 13 that drives the belt conveyor BC1 and other belt conveyors, and to a control apparatus 12 for controlling all of the apparatuses.

An apparatus having the same configuration as the droplet discharge apparatus 10 shown in FIG. 1 may be used as the discharge apparatuses 10a and 10b. In the positive electrode manufacturing line 202 shown in FIG. 6, compositions a and b are discharged using separate discharge apparatuses (discharge apparatus 10a and discharge apparatus 10b), but the compositions a and b may be discharged using a single discharge apparatus.

First, aluminum foil or another metal foil having a desired size is prepared. A collector is transported on the belt conveyor BC1 and taken into the discharge apparatus 10a. Composition a is discharged into a prescribed area on the collector by using the discharge apparatus 10a. The same pattern (same composition) may be repeatedly drawn in the same location to form a coated film of composition a to achieve a desired thickness.

The collector on which the coated film of composition a is formed is subsequently taken out of the discharge apparatus 10a, transported on the belt conveyor BC1, and taken into the discharge apparatus 10b. Composition b is discharged in a prescribed area on the collector by using the discharge apparatus 10b. The same pattern (same composition) may be repeatedly drawn in the same location to form a coated film of composition b to achieve a desired thickness.

The collector on which the coated film of compositions a and b is formed is then taken out of the discharge apparatus 10b, transported on the belt conveyor BC1, and taken into the heating/drying apparatus 11a. The coated film of compositions a and b is heated and dried by the heating/drying apparatus 11a to form the positive electrode layer shown in FIG. 4. The heating temperature of the heating/drying apparatus 11a may be a temperature that allows the solvent contained in the compositions a and b to be completely dried away. The temperature is ordinarily in a range of 50° C. to 200° C.

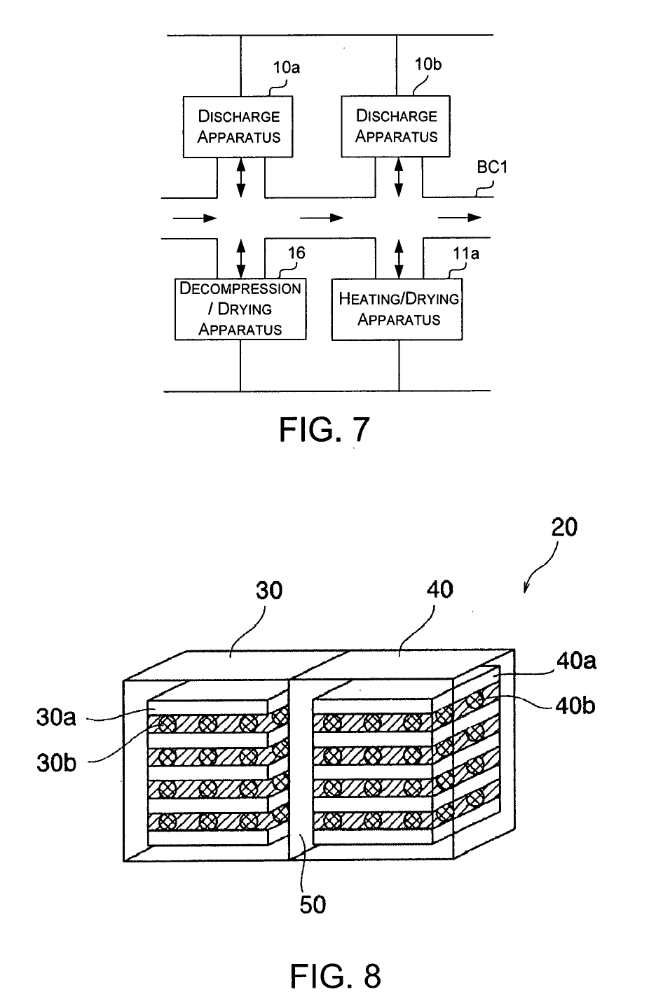

In the present invention, after a decompression/drying apparatus to treat the coated film of composition a formed on the collector in the discharge apparatus 10a, 16, as shown in FIG. 7, transport the collector provided with the coated film of composition a into the decompression/drying apparatus 16, dry the coated film of composition a, and then apply composition b in the discharge apparatus 10b.

The average thickness of the positive electrode layer formed in the manner described above is not particularly limited, but a thickness in a range of 5 μm to 50 μm is preferred. The average thickness of the electrode in which an electrode layer has been formed on a collector is preferably in a range of 10 μm to 70 μm. The thickness of the electrode and cell can be measured using a known micrometer.

The electrode surface area is not particularly limited, but it generally becomes difficult to maintain the uniformity of the electrode surface as the electrode surface area is increased. From this standpoint, the present invention is particularly useful when the electrode surface is 50 cm² or more.

The positive electrode layer obtained in the manner described above is configured so that composition a contains an electroconductive material, and composition b contains a positive electrode active material. When a positive electrode layer is formed in a desired pattern, a state is formed in which some of the particles of the positive electrode active material are in contact with the microparticles of the electroconductive material electrically connected to the collector. In other words, since a portion of the positive electrode active material is disposed so as to be in close contact with the electroconductive material, an electroconductive path is established, the internal resistance can be reduced, and good electron conductivity can be assured. In accordance with the present invention, the intended pattern does not degrade, and required energy can therefore by easily obtained (higher output) even when charging and discharging is carried out using large electric currents in accordance with the design.

Also, in coated patterns that have three or more compositions containing different electrode-forming materials, the order in which the other plurality of compositions is discharged is not particularly limited as long as the composition having the smallest coating surface area in relative terms is applied first. However, compositions having a relatively small coated surface area are preferably applied earlier in the sequence in order to form an electrode layer in which the intended pattern does not degrade and is in accordance with the design.

### Method for Manufacturing Secondary Cell

The method for manufacturing a secondary cell of the present invention is a method for manufacturing a secondary cell having a negative electrode, an electrolyte, and a positive electrode having a positive electrode layer composed of two or more positive electrode materials, the method comprising the step of forming the positive electrode layer having a prescribed pattern to form a positive electrode by first applying the material having the smallest coating surface area in relative terms among the two or more positive electrode materials, and then applying the material having the greatest coating surface area in relative terms, to a collector in accordance with a prescribed coating pattern.

In the method for manufacturing a secondary cell of the present invention, a secondary cell in which the electrodes have the intended charging and discharging characteristics can be obtained because a positive electrode can be manufactured in the same manner as in the method for manufacturing an electrode according to the present invention.

A secondary cell is composed of a positive electrode, an electrolyte, and a negative electrode arranged in the stated order, and these are sealed in an enclosure. Specifically, the positive and negative electrodes are manufactured, an electrolyte is disposed between the resulting positive and negative electrodes, and these components are sealed in an enclosure, whereby a secondary cell can be assembled.

The method for manufacturing a secondary cell of the present invention can be implemented by using the electrode manufacturing line 200 for a secondary cell shown in FIG. 6.

Specifically, in the manufacturing line 200, a positive electrode is manufactured using the above-described electrode manufacturing line 202 inside in the broken line. In a parallel process, a negative electrode is formed in the same manner as in the method for manufacturing the positive electrode by using a manufacturing line for manufacturing a negative electrode composed of a droplet discharge apparatus (discharge apparatus) 10c, a heating/drying apparatus 11b, and a belt conveyor BC2. The resulting positive and negative electrodes are accommodated in an enclosure in an assembly apparatus 15, and the electrolyte is supplied to and sealed inside the assembly by using an electrolyte supply apparatus 14, whereby a secondary cell can be manufactured.

An example of a lithium secondary cell obtained using the method for manufacturing the present invention is shown in FIG. 8. The lithium secondary cell 20 shown in FIG. 8 is a lithium secondary cell in which the positive electrode 30 and negative electrode 40 are partitioned by a separator 50.

In FIG. 8, the positive electrode 30 has a structure in which a collector 30a and a positive electrode layer 30b are layered in series, and the negative electrode 40 has a structure in which a collector 40a and a negative electrode layer 40b are layered in series. An electrolyte that is not shown in the diagram is filled into the interior of the positive and negative electrodes.

Examples of the electrolyte include, LiCIO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(CF₃SO₂)₂, LiCₙF₂ₙ₊₁SO₃ (n≧2), LiN(RfOSO₂)₂ (wherein Rf is a fluoroalkyl group), LiN(CF₃SO₂)(C₄F₉SO₂), LiN(C₂F₅SO₂)(C₄F₉SO₂), LiN(CF₃SO₂)(C₂F₅SO₂); a macromer of ethylene oxide and propylene oxide; gel polymer electrolytes, true polymer electrolytes, LiPON, and other inorganic solid electrolytes comprising various polymers; and Li ion-containing salts dissolving at normal temperature.

When the electrolyte contains a solvent, the solvent may be, e.g., 1,2-dimethoxyethane, 1,2-diethoxyethane, propylene carbonate, ethylene carbonate, ν-butyrolactone, tetrahydrofuran, 1,3-dioxolane, diethyl carbonate, dimethyl carbonate, or ethyl methyl carbonate. These may be used alone or in a plural combination.

The separator is not particularly limited as long as the separator can withstand the service range of the secondary cell. Examples include polyethylene, polypropylene, and other olefin-based resins; copolymers of polypropylene, polyethylene, and the like; and other fine porous films. These films may be used alone or in combination. The thickness of the separator is not particularly limited, but the thickness is ordinarily 10 to 50 μm.

The enclosure is not particularly limited, and an example is a polymer metal composite film or the like in which at least a metal foil film and a resin film are layered.

In the industrial production process for a secondary cell, a step may be adopted in which an electrode that is larger than the ultimate size of the cell may be fabricated and cut into prescribed sizes in order to improve productivity.

The shape of the secondary cell may be a stacked, cylindrical, flat, or another shape. A stacked secondary cell, for example, can be manufactured by cutting the positive and negative electrodes manufactured in the manner described above into suitable sizes, mounting terminals, holding the electrolyte material between the two electrodes under a dry argon atmosphere, and vacuum sealing the assembly inside an aluminum stack in a state in which the terminals have been brought out to the exterior.

A cylindrical secondary cell can be manufactured, for example, by layering the positive electrode, separator, negative electrode, and separator in sequence in a winding fashion by using the positive and negative electrodes manufactured in the manner described above, cutting the cell at a prescribed length, inserting the cell in a cylindrical iron can, adding an electrolyte, and sealing the can.

In the lithium secondary cell 20 shown in FIG. 8, LiCoO₂, for example, is used as the positive electrode active material, and carbon (C) is used as the negative electrode active material. Charging and discharging can be repeated as shown below.

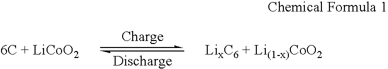

In the chemical formula 1 above, the value x is a positive number that is less than 1.

The cell manufactured in accordance with the present invention is particularly useful when used in vehicles that require high output, high energy density, and other rigorous conditions. The resulting cell has high durability in relation to vibrations, and cell degradation due to resonance does not easily occur even when used in vehicles and other environments in which vibrations are always present.

Preferred embodiments of the present invention were described above with reference to the attached diagrams, but embodiments of the present invention are not limited the above-described embodiments. The present invention is not limited to the above-described embodiments, and various modifications can naturally be made within a scope that does not depart from the spirit of the present invention.

In the embodiments, specific examples of a functional film composed of two or more functional materials were described with reference to an electrode layer composed of two or more materials for forming an electrode layer, but as noted in the embodiments, the functional film is not limited to an electrode layer. The functional film may be a circuit film having a wiring pattern composed of electroconductive films and an insulation layer embedded between the electroconductive films. The functional film may be an intermediate film that is layered between layered circuit films when the circuit films are layered to form a circuit or the like. The functional film may be an intermediate film composed of an insulation film for providing insulation between the circuit patterns of circuit films on both sides of the intermediate film, and a conductive layer for providing suitable conduction between the circuit patterns.

In the embodiments described above, the pattern data of the application patterns for the compositions was obtained by a method in which information required for drawing a pattern is input through an input terminal 102 into a computer 100, the drawing unit 101 of the computer 100 draws a pattern on the basis of the inputted information, and the drawn pattern data is stored in the storage apparatus 103. However, it is not required that computer form the drawing pattern data. The coating pattern data may be separately created in the design stage or at another time, and the data may be inputted into a coating apparatus.

In the present embodiment, an example was described in which an inkjet droplet discharge apparatus was used as the discharge apparatus, but the discharge apparatus is not limited to an inkjet droplet discharge apparatus. Any apparatus may be used as long as the apparatus discharges liquid material from a dispenser or is otherwise capable of placing any amount of liquid material in any position of a discharge target.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method for forming a functional film having at least first and second functional materials arranged in accordance with a prescribed coating pattern on a substrate, the method comprising:
discharging the first functional material having a smaller coating surface area than the second functional material according to the prescribed coating pattern onto the substrate using a droplet discharge apparatus; and
discharging the second functional material according to the prescribed coating pattern onto the substrate using the droplet discharge apparatus after the first functional material is discharged onto the substrate.

2. A method for manufacturing an electrode including an electrode layer having first and second electrode layer forming materials arranged in accordance with a prescribed coating pattern on a collector, the method comprising:
discharging the first electrode layer forming material having a smaller coating surface area than the second electrode layer forming material according to the prescribed coating pattern onto the collector using a droplet discharge apparatus; and
discharging the second electrode layer forming material according to the prescribed coating pattern onto the substrate using the droplet discharge apparatus after the first electrode layer forming material is discharged onto the substrate.

3. The method for manufacturing an electrode according to claim 2, wherein
the first electrode layer forming material includes one of positive electrode active material and carbon-based electroconductive material, and the second electrode layer forming material includes the other one of the positive electrode active material and the carbon-based electroconductive material so that the electrode layer formed is a positive electrode of a secondary cell.

4. A method for manufacturing a secondary cell having a negative electrode, an electrolyte, and a positive electrode layer having at least first and second positive electrode materials arranged in accordance with a prescribed coating pattern, the method comprising:
applying the first positive electrode material having a smaller coating surface area than the second positive electrode material according to the prescribed coating pattern onto a collector; and
applying the second positive electrode material according to the prescribed coating pattern onto the substrate after the first positive electrode material is discharged onto the substrate.

5. A method for forming a functional film that includes first and second functional film patches composed of mutually different first and second functional materials, respectively, formed on a substrate such that at least part of the first and second functional film patches are configured to be in mutual contact at a boundary therebetween, the method comprising:
determining a first area corresponding to the first functional film patch and a second area corresponding to the second functional film patch;
applying a liquid material containing the first functional material to the first area on the substrate that has a smaller surface area than the second area; and
applying a liquid material containing the second functional material to the second area on the substrate after the liquid material containing the first functional material is applied to the first area.

6. The method for forming a functional film according to claim 5, wherein
the applying of the liquid material containing the first functional material and the liquid material containing the second functional material include discharging the liquid materials toward the substrate by using a droplet discharge apparatus.

7. A method for manufacturing an electrode that includes first and second electrode layer patches composed of mutually different first and second electrode layer materials, respectively, formed on a collector such that at least part of the first and second electrode layer patches are configured to be in mutual contact at a boundary therebetween, the method comprising:
determining a first area corresponding to the first electrode layer patch and a second area corresponding to the second electrode layer patch;
applying a liquid material containing the first electrode layer material to the first area on the collector that has a smaller surface area than the second area; and
applying a liquid material containing the second electrode layer material to the second area on the collector after the liquid material containing the first electrode layer material is applied to the first area.

8. The method for manufacturing an electrode according to claim 7, wherein
the liquid material containing the first electrode layer material includes one of positive electrode active material and carbon-based electroconductive material, and the liquid material containing the second electrode layer material includes the other one of the positive electrode active material and the carbon-based electroconductive material so that the electrode layer formed is a positive electrode of a secondary cell.

9. The method for manufacturing an electrode according to claim 7, wherein
the applying of the liquid material containing the first electrode layer material and the liquid material containing the second electrode layer material include discharging the liquid materials toward the collector by using a droplet discharge apparatus.

10. The method for manufacturing an electrode according to claim 8, wherein
the applying of the liquid material containing the first electrode layer material and the liquid material containing the second electrode layer material include discharging the liquid materials toward the collector by using a droplet discharge apparatus.

11. A method for manufacturing a secondary cell having a negative positive electrode, an electrolyte, and a positive electrode with a positive electrode layer including first and second positive electrode layer patches composed of mutually different first and second positive electrode layer materials, respectively, formed on a collector such that at least part of the first and second positive electrode layer patches are configured to be in mutual contact at a boundary therebetween, the method comprising:
determining a first area corresponding to the first positive electrode layer patch and a second area corresponding to the second positive electrode layer patch;
applying a liquid material containing the first positive electrode layer material to the first area on the collector that has a smaller surface area than the second area; and
applying a liquid material containing the second positive electrode layer material to the second area on the collector after the liquid material containing the first positive electrode layer material is applied to the first area.
